(19) United States
(12) Patent Application Publication
(10) Pub. No.: US 2006/0193004 A1
(43) Pub. Date: Aug. 31, 2006

(54) Method of integrating imaging products/services with non-imaging products/services in a single kiosk

(75) Inventors: Jerome J. Wasilewski, Rochester, NY (US); Daniel J. Abens, Roswell, GA (US); John R. Fredlund, Rochester, NY (US); Joseph A. Manico, Rochester, NY (US)

Correspondence Address: Mark G. Bocchetti;Patent Legal Staff, Eastman Kodak Company, 343 State Street, Rochester, NY, 14650-2201, US

(73) Assignee: Eastman Kodak Company

(21) Appl. No.: 11/370,492

(22) Filed: Mar. 8, 2006

Related U.S. Application Data
(63) Continuation-in-part of application No. 09/779,335, filed on Feb. 8, 2001.

(51) Int. Cl. G06F 3/12

(52) U.S. Cl. 358/1.15; 382/115

(57) ABSTRACT

A method of integrating photographic imaging products and services functionality with non-imaging functionality using automatic teller machine (ATM) functions for providing financial transactions in a single kiosk is disclosed. This invention provides the consumer with the flexibility to generate imaging products and conduct imaging services or perform ATM-related transactions independent of one another; to incorporate images into producing customized financial instruments at the kiosk; to access financial institution services to store or retrieve images or documents as part of providing either imaging products/services or ATM financial instruments; and to utilize the customer's financial accounts and/or financial instruments as a means of payment for the products/services rendered at the kiosk. The present invention leverages the infrastructure, equipment and networking capabilities of both sets of functionality to provide an economy of scale and an increased value of differentiation not currently available.

### CROSS-REFERENCE TO RELATED APPLICATIONS

This is a continuation-in-part of application Ser. No. 09/779,335, filed Feb. 8, 2001 entitled “METHOD OF INTEGRATING IMAGING PRODUCTS/SERVICES WITH NON-IMAGING PRODUCTS/SERVICES IN A SINGLE KIOSK” by Jerome J. Wasilewski et al.

### FIELD OF THE INVENTION

The invention relates to the field of kiosks, and more particularly, to a combined kiosk for photographic image producing image goods and/or service kiosks and non-imaging products and/or services such as an Automatic Teller Machine (ATM) kiosk, providing many secured functions.

### BACKGROUND OF THE INVENTION

Image-producing kiosks are well known. An example is the Kodak Picture Maker™. This kiosk is capable of scanning prints to create a digital image file, importing digital image files from various media or from remote storage via a network connection, and creating reprints and enlargements from the scan or digital image file. The kiosk can also add borders and do other manipulations to the image to increase its value. It is known to network image-producing kiosks, capable of sending files to and receiving files from a remote location, as well as providing credit card transaction processing.

U.S. Pat. No. 5,459,819 is directed to a kiosk focused on the flexibility of generating a combined, composite image from a variety of source images and is limited to image generation, which, in part, provides the input for the image producing products/services functionality of the integrated kiosk.

U.S. Pat. Nos. 5,623,581 and 5,913,019 are both limited to capturing an image, superimposing it on a selected background, and having the composite image printed as a set of stickers. They do not address the flexibility of creating an image from a single or multiple set of image captures and performing edits and enhancements to produce a multiplicity of image products and services.

Automatic Teller Machine (ATM) kiosks are also well known. Such kiosks are capable of accessing a customer financial banking account for status, as well as crediting, debiting, and transferring monetary funds. They are also capable of accepting a physical monetary deposit and/or withdrawal, along with disbursing funds. They are typically networked through the financial institution infrastructure. They may also have a security monitoring camera device. ATMs today are limited to disbursement of bank notes/cash or goods, as from a vending machine. They do not address the generation of personal bank products using imaging (either in the process or integral to the bank product), nor do they address the creation of imaging goods or provide imaging services as part of their disbursement process.

U.S. Pat. No. 5,764,789 discloses the use of biometrics as part of the personal authentication process for customers to access their financial account. It does not address the use of biometrics as a digital watermark to secure a transaction nor incorporation into a kiosk product.

U.S. Pat. Nos. 5,859,920; 5,905,819; 6,044,182; and 6,136,752 disclose a method of embedding digital information in an image and of providing image authentication. It does not address the flexibility and enhancement in the use of watermarked images in non-imaging applications or incorporation into a kiosk product/service.

U.S. Pat. No. 5,774,663 discloses the communications between a customer and a specific financial institution. This patent does not address employing a third party in the financial transaction process.

Internet kiosks are also known. Through browser technology and Internet access, one can search the World Wide Web (WWW) to gain access to a number of web sites. U.S. Pat. No. 5,761,071 discloses the use of browser technology as the kiosk graphical user interface interaction with the user for a standalone, Internet-accessible kiosk. It does not address the image and non-imaging functionality within the integrated kiosk for providing products and services associated with that functionality. These web sites can only offer a wide variety of imaging and non-imaging (such as banking) products/services that can be fulfilled within their supporting infrastructure and then distributed to the customer either via the Internet or physically shipped.

Kiosks for providing identification documents such as licenses, passports, and credit cards are known, as described in WO 99/66448. Such kiosks use biometric data and/or images for identification. Kiosks providing such biometric information on a card for use with the kiosk for future product or service orders are also known, as described in WO 99/30267.

The above patents fail to teach or suggest a method by which the functionality of an imaging producing kiosk is integrated with the functionality of a non-imaging producing kiosk, such as an ATM kiosk, into a single kiosk that dispenses products and services associated with both types of functionality at the kiosk.

There is a need to provide a kiosk with the ability to import photographic images (i.e.; scanned from film; transferred digitally from a digital still camera, hand-held device or memory device; or downloaded from an Internet-enabled storage location); process digital photographic images (i.e., remove “red eye,” zoom and crop, add borders and text, etc.); provide print fulfillment services (i.e., outputting hardcopy print product or a digital file at the kiosk, sending e-mail product services, uploading and downloading the digital file to/from an Internet-enabled remote storage location, or remotely printing and distributing images); and the ability to conduct a plurality of financial transactions that use imaging as part of the product/service.

### ADVANTAGES

A kiosk made in accordance with the present invention leverages the usage of the existing infrastructure, as well as equipment and networking capabilities across functionality types (that is, imaging and non-imaging), replacing two or more kiosks with one. Cost reduction is achieved through elimination of redundant equipment and efficiency of use of the kiosk.

The present invention also provides the ability to generate custom financial instruments (e.g., debit card, credit card, traveler checks) with a specific selected image, for example an image of the recipient, to provide added security against fraudulent transactions. Through image processing techniques, the subject is isolated from the background to provide a distinct image for these financial instruments, as well as for image products. Enhanced security and authorization are also achieved by applying the image captured with a personal identifier scanning device, or other biometric data, for comparison to a local database or a remote database via a communication network. Also, utilizing the network, remote financial transactions using personal identification information can be rendered locally at the kiosk. A variety of secured transactions can be performed, including deposit of secure documents, notarization of documents, provision of identification cards or tags, ticketing, or like functionalities.

### SUMMARY OF THE INVENTION

This invention describes the methods for using an individually integrated kiosk that combines the photographic imaging products/services functionality of an imaging kiosk, with the non-imaging products/services functionality of a non-imaging type kiosk, including Automatic Teller Machine (ATM) functionality.

According to one aspect of the present invention, there is provided a method of conducting a secured kiosk transaction, comprising:
receiving user data comprising personal data, biometric data, or a combination thereof;
comparing the user data to known user information;
performing a transaction; and
providing a detailed record of the transaction to the user,
wherein the transaction is one of safe-deposit or withdrawal of a document, notarization of a document, transportation ticket obtainment, user location verification, or payment of government fees.

### BRIEF DESCRIPTION OF THE DRAWINGS

In the detailed description of the preferred embodiments of the invention presented below, reference is made to the accompanying drawings in which:

FIG. 1 illustrates a prior art image-producing kiosk;

FIG. 2 illustrates a prior art ATM kiosk, as a non-imaging producing kiosk;

FIG. 3 illustrates an integrated kiosk made in accordance with the present invention having the capability to provide both imaging and non-imaging products/services;

FIG. 4 sets forth a list of common architecture elements of a prior art kiosk of FIG. 1 and prior art kiosk of FIG. 2;

FIG. 5 illustrates a flow chart of a method for dispensing imaging products and/or services from an integrated kiosk made in accordance with the present invention;

FIG. 6 illustrates a flow chart of methods for dispensing ATM products/services from an integrated kiosk made in accordance with present invention;

FIG. 7 illustrates a custom product produced from a kiosk made in accordance with the present invention; and

FIG. 8 illustrates a system for utilizing remote services and applications of an integrated kiosk made in accordance with the present invention.

### DETAILED DESCRIPTION OF THE INVENTION

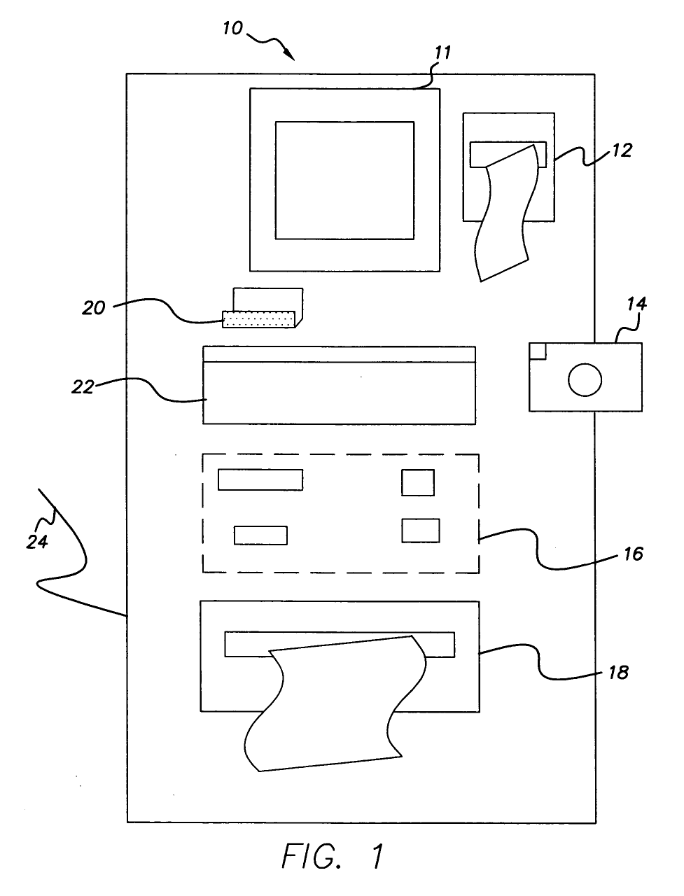

Referring to FIG. 1, there is illustrated a prior art kiosk 10 which provides imaging products and services. Kiosk 10 represents a composite of key components for producing imaging products and providing imaging services. The kiosk 10 includes a touch screen user interface 11 that provides user instructions and/or prompts and allows data entry by the user to kiosk 10. In the embodiment illustrated, the screen user interface 11 comprises a touch screen as is well known in the art. The user can scan a photo or other document using the image scanner 22 or, if available, use an attached digital image camera 14 to capture a digital image. A computer 16 is provided in kiosk 10 for controlling operation of the kiosk 10. The kiosk 10 may also be equipped with peripherals to read digital image files from various sources, such as memory cards and portable storage devices like CDs, memory sticks, camera memory cards, and floppy or zip disks. Through the user interface 11 and application software that resides in the computer 16, the consumer/customer selects an imaging product or service, and is then instructed to perform the appropriate set of operations. This may include a financial transaction for payment for the imaging product/service using a multi-card reader 20 for credit card, debit card, or smart card processing. A network connection 24 can be provided in kiosk 10 to support the transaction processing, as well as provide other appropriate network services and support. Upon approval of payment, an image product can be generated. For example, a small size image printer 12 can be provided in kiosk 10 for use in generating photo ID or small sticker sheet output. In addition, a larger size image printer 18 can be provided for generating larger image reproduction or large sticker sheet output. Other image product outputs can be provided over-the-counter or sent to the consumer.

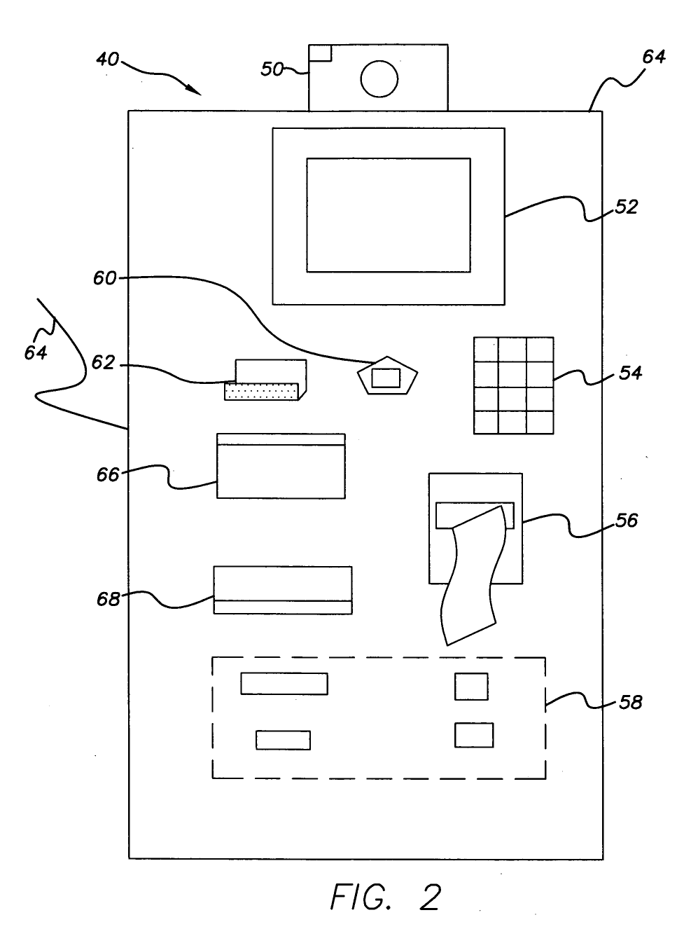

Referring to FIG. 2, there is illustrated a typical prior art ATM kiosk 40 used for financial transactions provided by a financial institution. A security camera 50 typically monitors the consumer at the kiosk 40. Through a user display device 52 provided on kiosk 40, the consumer is instructed to select the desired transaction and use data entry device 54 for selections and data entry. In the embodiment illustrated, display device 52 comprises a CRT and data entry device 54 comprises a keypad. It is to be understood that display device 52 and data entry device 54 may be any well-known substitute. Kiosk 40 includes control and application software that resides on an associated computer 58 also provided in kiosk 40. A network connection 64 is provided in kiosk 40 to support the transaction processing. For any deposits, the consumer uses an envelope deposit slot 66 provided on kiosk 40. For transactions requiring a credit card, debit card, or smart card, the consumer swipes the card through the multi-card reader 62 provided on kiosk 40. When a transaction requires the consumer to provide a written signature or other biometric data, such as a fingerprint, the writing pad/sensor plate 60 provided on kiosk 40 can be used. Any disbursement transaction can be made to the consumer via the financial instrument dispenser 68. The receipt printer 56 provided on kiosk 40 can generate a printout confirmation of the processed transaction.

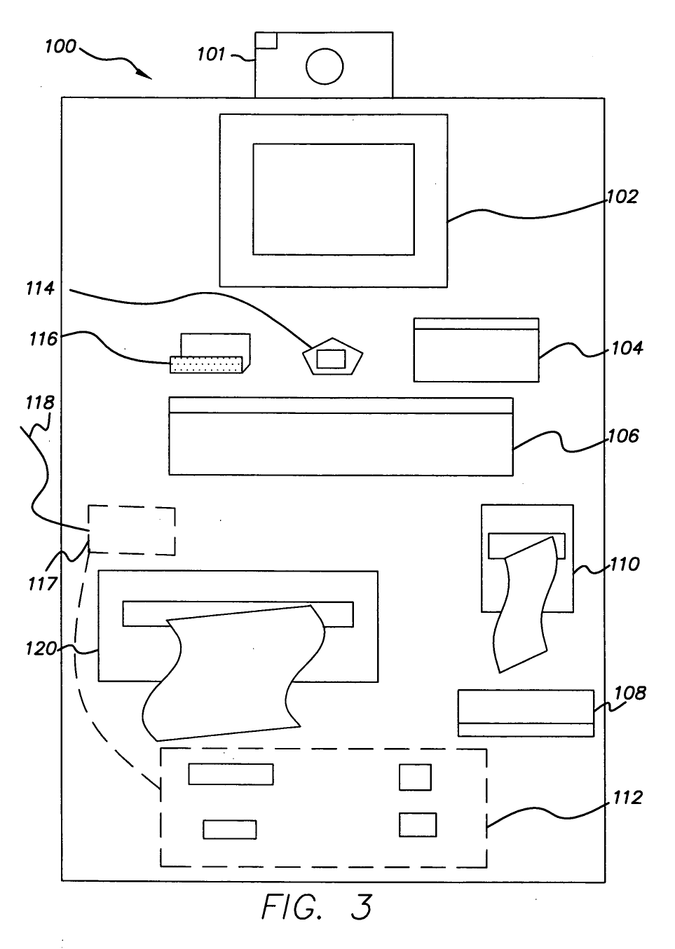

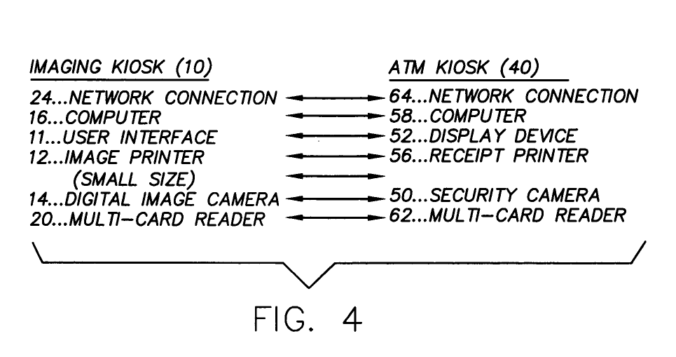

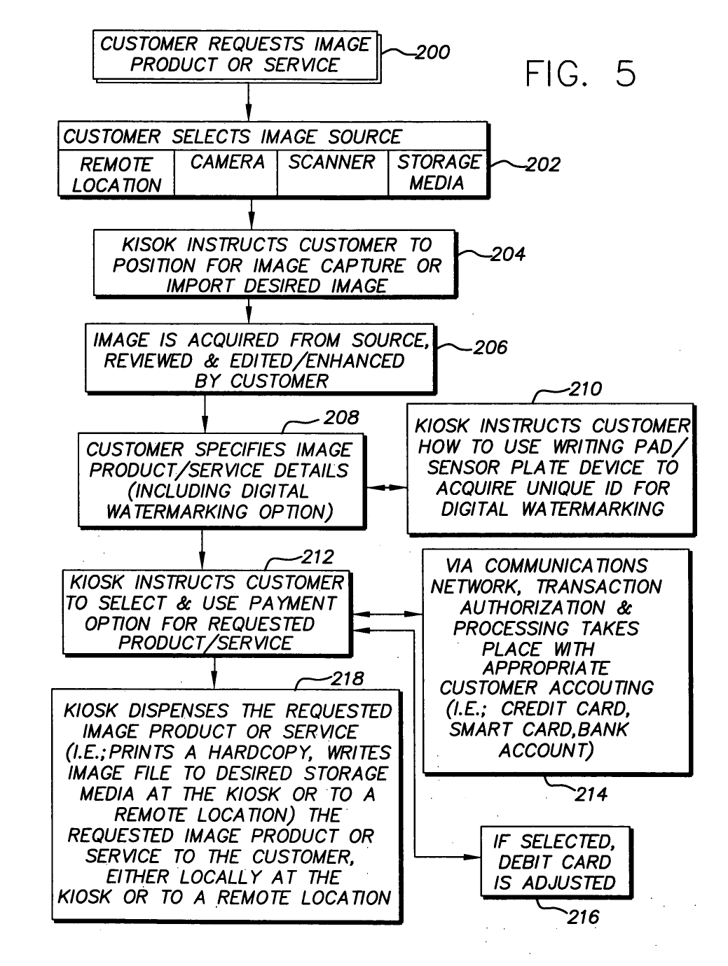

Referring to FIG. 3, there is illustrated a kiosk 100 made in accordance with the present invention. The kiosk 100 incorporates the functionality of both an imaging kiosk and an ATM kiosk into a single kiosk unit. FIG. 4 sets forth a list of common architecture elements of a prior art kiosk of FIG. 1 and prior art kiosk of FIG. 2. The kiosk 100 includes a customer device and display device. In the embodiment illustrated, the kiosk 100 uses a touch display screen user interface 102 as a display device to display instructions and prompts, and as an input device for allowing a customer to enter data for conducting business. It is of course understood that any appropriate display device and/or data entry device may be employed to support the functions of the kiosk 100. The kiosk 100 can include an imaging camera 101, which can provide security monitoring, personal identification, and a means for capturing an image for image-based products. Alternately, the customer can capture a digital image from a photograph or document using the image scanner 106 provided on kiosk 100, or import a digital image file stored on various media (e.g., CD, memory card/stick, disk, or remote server) using the various input devices not shown, but provided, on kiosk 100. These devices are appropriately connected to a computer 112 provided in kiosk 100. The computer 112 also controls kiosk 100 and uses the appropriate software applications for supporting operations at kiosk 100. The kiosk 100 also includes a communication device 117 for providing communication over a network connection 118 that supports the transaction processing and other application communication network services and support, such as “back lab processing” for high volume image printing. The network connection 118 may be of a broad bandwidth type or of a low bandwidth type, the broad bandwidth being used for large files, such as image files, and the low bandwidth type being used for transmission of small data files. For example, a phone line may be used for the small data files and a cable type connection could be used for large image type files. Preferably, the kiosk 100 would have both types of connections. The kiosk can use a wired or wireless network connection. In addition, the kiosk 100 may employ data compression algorithms to support transmission of data. Further, at least one transmission line can be a secure line for transmission of personal data or biometric information. Such a line may use encrypted data or other known security protocols.

Personal data as used herein can include any information capable of identifying an individual when used alone or in combination with other information. Examples of personal data can include, but are not limited to, customer's birth date, social security number, mother's maiden name, full name, password, personal identification number, account number, tax identification number, vehicle identification number, real estate parcel number, license number, passport or visa number, or credit card, debit card or smart card number.

Biometric data can include any measurable physical characteristic or personal behavioral trait reasonably identified with a specific individual. For example, biometric data can include face recognition, fingerprint recognition, iris or retina pattern recognition, voice recognition, vascular pattern recognition of arteries or veins, hand recognition, or DNA matching. Other forms of measurable biometric data are also contemplated for use herein.

Any user data such as personal data or biometric data can be verified by comparison to a database as conducted by a computer or by a person, or by real-time review and confirmation by a person connected to the kiosk at the same time as the customer.

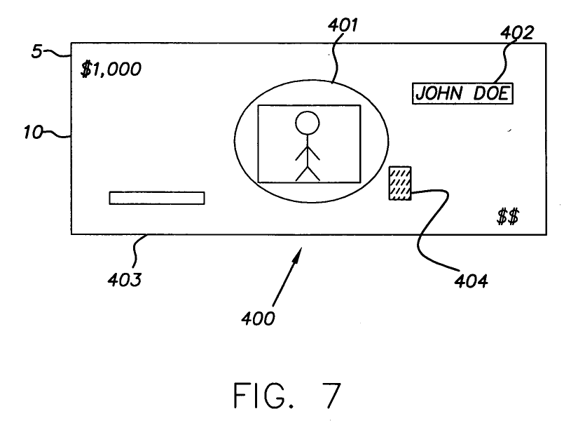

For a financial transaction requiring a monetary deposit, the customer uses the envelope deposit slot 104. For transactions requiring a credit card, debit card or smart card, for example, imaging or ATM transactions, the consumer swipes the card through a multi-card reader 116. Where a product or service requires the consumer to provide biometric identification through a written signature or a fingerprint, a writing pad/sensor plate 114 provided on kiosk 100 is used. The imaging camera 101 can be used for biometric identification, providing visualization verification of the customer or other individual at kiosk 100 as well as being a capture device for other biometric data such as iris scanning or retinal scanning. Upon payment approval, imaging and financial products can be generated by kiosk 100. A small size image printer 110 provided on kiosk 100 can be used for small-sized various imaging products. In the embodiment illustrated, printer 110 can be used to produce personalized financial instruments such as traveler checks as illustrated in FIG. 7. Kiosk 100 in the preferred embodiment can also include a large size image printer 120 for larger-sized imaging products. Financial instrument disbursements, as part of a financial transaction, can be made to the consumer using the financial instrument dispenser 108. A receipt printout, confirming the processed transaction, can be generated by a smaller size printer 110. Various combinations of two or more printing devices can be used, wherein each printer can be the same or different size, type, or speed than at least one other printers. A single printer can be used, preferably carrying larger media or a media roll that can be cut to different lengths based on the type of printout to minimize waste. Each printer can be an ink jet, thermal, thermographic, pressure sensitive, or laser printer, and can print in color or black and white. Some or all printing functions can be located remotely, such as at a service desk, printer bank, or home printer.

The kiosk 100 can be used for ordering of image products and/or services or as an ATM. Referring to FIG. 5, there is shown a flow diagram of one type of operation of the kiosk 100. When a customer, desires to request an image product and/or service 200, the customer initiates a request on kiosk 100 and follows the prompts on the touch screen user interface 102. The customer selects the image source 202 of an image. For example, the customer can obtain an image from a remote location via the network connection 118, an imaging camera 101, an image scanner 106, from a file stored on media such as a CD, memory card/stick, or disk using the peripheral options available on the computer 112, or from a portable device such as a camera phone, laptop, digital camera, or image viewer by wired or wireless communication, so as to begin the image acquisition process 204. Once the image is acquired, the customer can perform any image edits or enhancements allowed by kiosk 100 to get the desired image 206 for the image product/service. The customer is also prompted to select the particular image product/service 208. Prior to rendering the image product/service, the customer is prompted to select a desired payment method, for example, debit card, credit card, smart card, or cash via ATM functionality using the multi-card reader 116 or ATM process 214, 216, via communication device 117 over the network connection 118. The multi-card reader 116 can have magnetic, optical, and/or computer chip reading capability. Upon payment approval, the kiosk dispenses the requested image product or service 218, or if remote processing is required, provides a receipt indicating a time or date for pickup of the product or on which delivery of the product to the customer's specified location, for example, the customer's home, will be made. If selected, digital prints can be generated at the large size image printer 120. Photo ID or Photo Sticker selections can be produced at the small size image printer 110. Other outputs at the kiosk include downloads to CD, memory card/stick, disk, and personal portable devices using the computer 112 peripherals, or wired or wireless communication. Optionally, a download can be made to a database or the Internet, or to customer's home computer if Internet accessible.

As part of the options during the image product/service process, the customer has the ability to embed into the image personal identification information 210, for example, as a digital watermark (for example, as described in U.S. Pat. Nos. 5,859,920; 5,905,819; 6,044,182; and 6,136,752) through the user interface 102, the writing pad/sensor plate 114, the imaging camera 101, or a scanner.

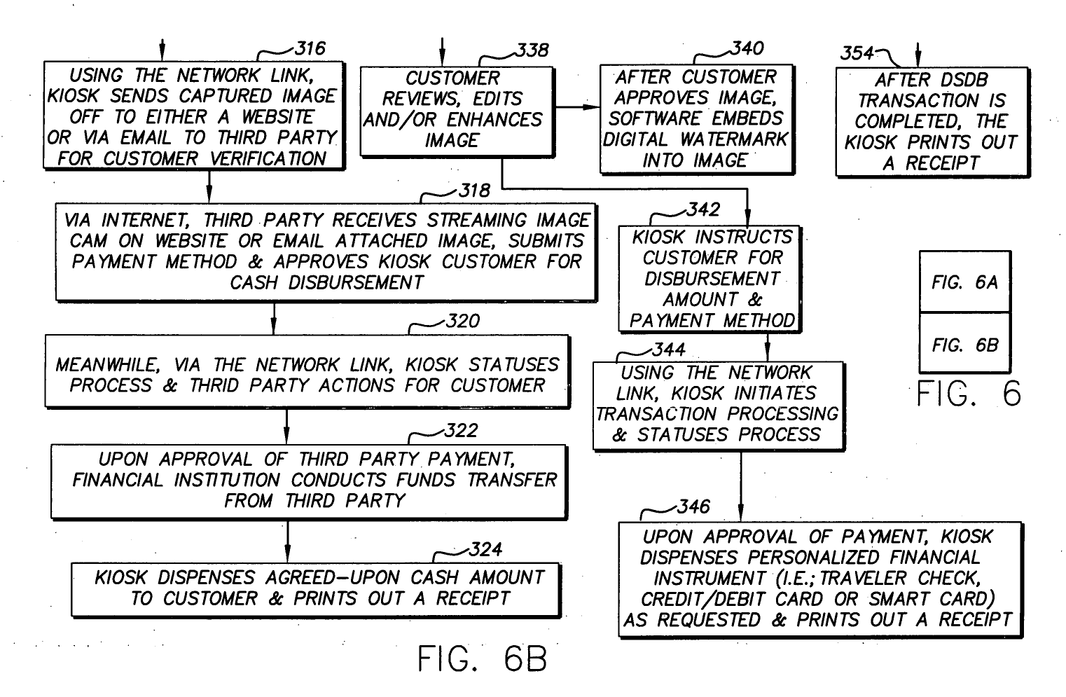

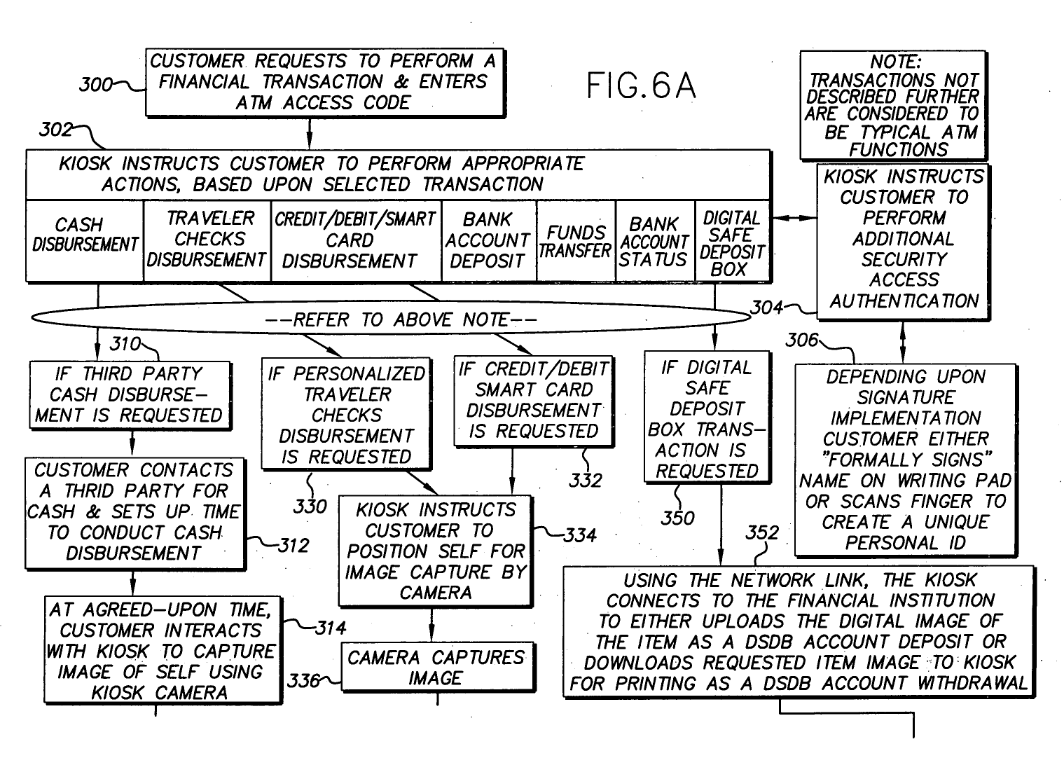

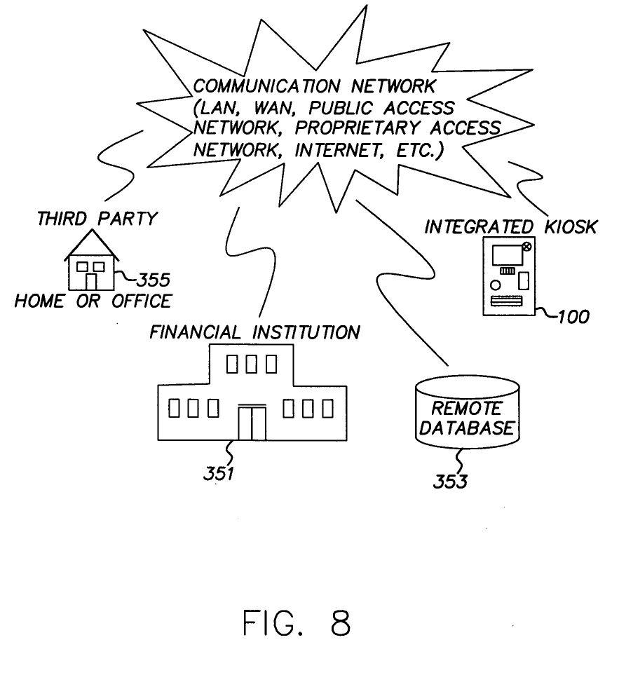

Referring to FIG. 6, there are illustrated various other forms of operation of the kiosk 100 in accordance with the present invention. For example, when a customer is interested in conducting a financial transaction 300 using kiosk 100, the customer can utilize user interface 102 and its associated screen prompts 302. In addition to, or as an alternative for, using a PIN, an image of the customer can be captured by imaging camera 101 and sent to a remote database 353, financial institution 350, or third party 355 (see FIG. 8) for authorization in conducting some ATM transactions. For example, the image of the customer could be sent to the third party responsible for the disbursement for visual verification, or verification can be made by comparing the captured image of the customer to an image on file using image recognition software. The imaging camera can be a still camera or video recorder.

Additional security measures can be taken to secure transactions 304. For example, when a signature is desired, the writing pad/sensor plate 114 can be used to authenticate the transaction process 306, or a signature can be scanned using the scanner for comparison to one on file. Alternately, any other biometric identification, such as a fingerprint, iris scan, retinal scan, hand scan, vein/artery pattern scan, voice sample, or DNA sample, can be taken for comparison to data on file. The information obtained can be analyzed and compared with stored information or information accessed over the communication network for verification. This verification can be done at the kiosk 100 or at the remote location. The verification can be by computer program, with or without human oversight, or by human interaction.

An envelope deposit slot 104 can provided for cash deposit transactions or document deposits. The multi-card reader 116 can provide non-cash deposit and withdrawal capability. The customer can follow the ATM prompts on the user interface 102, resulting in a financial transaction, which can include a cash disbursement at the financial instrument dispenser 108. After the financial transaction has been completed, the smaller size printer 110 can provide a receipt as a record of the transaction 324, 346, 354.

In the prior two uses of the kiosk 100, the transaction and payment are made by the customer at the kiosk 100. The present invention allows for third party disbursement of funds 310 or payment on behalf of the customer at the kiosk 100. In one form of operation of the kiosk 100, the customer requesting the funds or services contacts a third party 355 (see FIG. 8) over a communication network, for example, over the Internet or using a telephone connected to the kiosk 100. Once the third party is connected to the kiosk 100, appropriate information can be entered by the third party over the communication network. This could be a valid credit card number, bank account, etc. This information need not be given to the customer, but instead the information could be entered directly into the kiosk 100 over the communication network by the third party. A phone can be provided at the kiosk to provide verification that the customer is whom the third party 355 wishes to make payment for, or to whom the third party is authorizing the release of funds. The imaging camera 101 could allow visual verification of the customer at the kiosk 100 when the communication network is the Internet and the third party is accessing the kiosk by a computer or other similar device. This allows the third party to view the customer for visual verification. The requested money or payment would then be authorized by the third party.

In another form of operation, the third party agrees to a specific time to approve and forward the cash to the requestor 312 kiosk 100. The requester (customer) goes to the integrated kiosk 100 and follows the user interface 102 prompts to capture an image of the requestor 314 from the imaging camera 101 and forward it via e-mail 316 or web link, such as Netmeeting or Instant Messenger, over a communications network connection 118, such as the internet, to the third party at home or at any other location where the third party will be located. Simultaneously, the third party accesses the communication network and opens e-mail or the web link to verify that the image is that of the requestor 318. The e-mail or web link can be used to identify the secure web site where the third party can link to conduct the transaction and approve the cash disbursement. Depending upon the Internet access capability of the third party, the third party could view the requestor for visual verification. Depending on the kiosk network connection 118 and configuration, the third party could alternatively view a live camera broadcast of the requester on the designated web site. Meanwhile, the user interface 102 can be checking the status of the third party activities 320. Upon approval 322, the requestor initiates the cash disbursement and the cash is dispensed 324 at the financial instrument dispenser 108. A receipt is then generated at the smaller sized printer 110. Also, a receipt via e-mail or text message can be sent to the third party to acknowledge that the transaction has been completed. An example of the above could be when a child, the customer, wishes to obtain funds from a parent or other individual from a remote location. The parent would then authorize the issuance of the funds at the kiosk.

In another form of operation of kiosk 100, the kiosk also has the capability to generate personalized financial instruments 330, 332, 400. As one of the ATM transaction options, a customer can purchase personalized checks, travelers checks, or other financial instruments through an appropriate financial institution 350, where the financial instruments incorporate an image 401 of the bearer, a fingerprint of the bearer, and/or the bearer's signature 402. For example, a personal identification icon 404 can be printed to provide visual authentication in using the financial instrument. Through the user interface 102, the customer is instructed 334 to either get an image captured 336 via the imaging camera 101, to scan a photograph on the image scanner 106, or to download an image. The customer reviews 338 and selects the desired image for the financial instrument. For securing the selected financial instrument 330, the customer optionally uses the writing pad/sensor plate 114 to capture the bearer's signature and/or fingerprint for printing a signature and/or fingerprint representation of the bearer. While the customer interfaces with the kiosk to identify the disbursement amount and payment method 342, the application software within the computer 112 digitally watermarks 340 the image using the customer's unique information (e.g., customer biometric information). The watermark provides the authentication of the financial instrument provided by kiosk 100. Use of watermarking is well known. Through the user interface 102 and network connection 118, the transaction process is initiated 344 and statused back to the customer. Upon approval of payment 346, the watermarked image, signature, and/or personal identification indicator 404 is printed on the financial instrument. The personal identification indicator 404 provides a visual indication to the bearer and receiver of the financial instrument that it is a registered financial instrument where the image is secured by an embedded digital watermark. The correct number of financial instruments, such as travelers checks, are dispensed into the financial instrument dispenser 108 or printed on an appropriate printer to equal the amount purchased. When the financial instrument is presented for payment at a desired merchant, the image on the financial instrument can be compared to the presenter; the presenter can be asked to provide a second signature, for example, at location 403 on a traveler's check, for comparison and verification of the signature; or a fingerprint of the presenter can be taken for comparison.

In the above embodiment, the financial instrument is obtained at kiosk 100 and presented to a desired merchant. It is also contemplated that a financial instrument having biometric information of the presenter could be cashed by the kiosk 100. For example if a financial instrument is made by a first kiosk 100, or by any other device, at a first location by a customer, the financial instrument could be presented to a second kiosk 100 for payment. The customer would follow the instructions and prompts on the user interface 102. The financial instrument would be inserted into a scanner in kiosk 100 that would obtain the biometric information on the instrument. Then the customer could sign the writing pad/sensor pad 114, or submit to a fingerprint, iris, retinal, face, hand, or vascular pattern scan, or provide a voiceprint or DNA. The computer could then apply an appropriate algorithm for verification of the signature and/or other biometric data. The imaging camera 101 could capture the image of the presenter and the computer could apply an image comparison program for verifying that the image captured by imaging camera 101 is the same as the image on the instrument. Upon approval, the customer would insert the signed financial instrument into the envelope deposit slot 104, have its value verified and then cash would then be disbursed at the financial instrument dispenser 108.

The kiosk can also provide secured transactions requiring verification of customer identification for generation of identification documents, financial cards, travel documentation, or legal purposes. For example, once the customer has been identified by one or more form of biometric data or personal data, a driver's license, passport, visa, identification card, or credit/debit card can be issued to the customer. Such card manufacturing devices are known and can be provided in the kiosk, or a receipt can be provided to the customer to pick up such an item at a retail counter or other specified location, or the item can be mailed to the user's home address. Necessary information can be entered through any peripheral devices already described, including scanning or imaging of necessary documents. Such interactions can require third party identification or authorization, wherein the third party is connected to the kiosk as described elsewhere herein or the third party is an attendant or clerk at the kiosk location, or the interaction can be automated, provided the customer's biometric and/or personal data can be verified by the system. The system can note any problems with identification or verification of the customer, and print a receipt or electronically transfer such information so the customer can proceed to the proper authority to correct the problem, such as a passport office or Department of Motor Vehicles.

The kiosk, having ATM functionalities, can also receive payments due after customer verification. In this manner, Department of Motor Vehicles registration or tax fees can be paid through the kiosk and properly credited. Similarly, a customer can pay other bills, including utility and local tax bills, using the kiosk. Recordation of property transfers and payment of applicable government fees and taxes can be made using the kiosk through connection to the appropriate state or local government database, and identification of the user through real estate identification number, tax payer identification number, parcel number, or vehicle identification number.

The customer can purchase tickets, such as airline, rail, bus, or vessel tickets once verification of the customer's identity is made, or print out a boarding pass for a previously purchased ticket. At transportation stations, each customer can also print luggage identification tickets as needed for attachment to shipped or carry-on luggage. Use of such a device could remove the need for identification checks, quickening security checks to only physical searches of persons and articles in transportation areas.

The kiosk can also be used to check employee location, particularly where an employee is on extensive travel or works from home. Weekly or daily check-in through the kiosk can be required, providing the employee with a receipt showing time of the check-in and the location of the kiosk. This can also be used for check-in with probation or parole officers, particularly if two-way communication through telephone or Internet is enabled. The kiosk enables verification of the identity of the customer, the time and place where they were at check-in, and provides the customer a receipt showing such information as proof of compliance with legal requirements of sentencing.

In another form of operation of kiosk 100, the customer can also have access to a personal Digital Safe Deposit Box (DSDB) at a financial institution 350, or another secure location or server. Following the instructions on the user interface 102, the customer can deposit, transfer, or withdraw contents 352 from an existing DSDB account, or into an account created during the transaction. To deposit into the DSDB account, the customer can either use the imaging camera 101 or the image scanner 106 to capture an image, or import a digital file at the computer 112 using the available peripherals, or from remote storage using the network connection 118. To withdraw from the DSDB account, an item image in the DSDB account can be generated at the image printer 120, or sent to the storage medium designated by the customer. Preferably, the physical print out and the digital file are marked with the date and time of withdrawal, visibly or by means of a watermark. A receipt can be generated 354 at the completion of the DSDB transaction indicating what items were added or removed, how they were transmitted (physical or digital), and, if digital, to or from what type of device or server. The document can be identified on the receipt by a document title, signatory name(s), an image of the document, or some combination thereof. If desired, the physical document can be placed in the kiosk through the slot for delivery to the financial institution or other document deposit holder.

The kiosk can also serve a notary function by verifying the identity of the customer and providing a receipt with customer name; personal identification such as personal data or biometric information; date and time; identification of the notarized document, for example, by title, a thumbnail, or reduced size image of the document; or some combination thereof. The kiosk can notarize documents by receiving a scanned or other digital image of the document, and printing out a copy of the document with an indication of notarization, including the time, date, and identification of the kiosk used.

Other transactions requiring security can be performed, as is evident to readers of this document. Recognizing that both secure and non-secure access is required to maintain the integrated kiosk, it is envisioned that a kiosk made in accordance with the present invention will have separate access means to handle each need (e.g., routine consumer replenishment, printer servicing, cash deposit removal, etc.).

For bank-related transactions, such as DSDB or notarization, a fee can be charged to the customer before the transaction can be completed. The fee can be based on whether the customer is using a kiosk associated with customer's financial institution, as is currently practiced with ATM access.

Various other types of non-imaging products/services kiosks share common features with an imaging kiosk, and can be integrated therewith as described herein to accommodate various combinations of functions, including imaging, financial transactions, and transactions requiring verification of customer's identity.

The invention has been described in detail with particular reference to certain preferred embodiments thereof, but it will be understood that variations and modifications can be effected within the spirit and scope of the invention.

### Parts List

10 Kiosk (Imaging)
11 User Interface
12 Image Printer (Small Size)
14 Digital Image Camera
16 Computer
18 Image Printer (Large Size)
20 Multi-Card Reader
22 Image Scanner
24 Network Connection
40 Kiosk (ATM)
50 Security Camera
52 Display Device
54 Data Entry Device
56 Receipt Printer
58 Computer
60 Writing Pad/Sensor Plate
62 Multi-Card Reader
64 Network Connection
66 Envelope Deposit Slot
68 Financial Instrument Dispenser
100 Integrated Kiosk
101 Imaging Camera
102 User Interface
104 Envelope Deposit Slot
106 Image Scanner
108 Financial Instrument Dispenser
110 Small Size Image Printer
112 Computer (including peripherals & supporting software)
114 Writing Pad/Sensor Plate
116 Multi-Card Reader
117 Communication Device
118 Network Connection (communications network)
120 Large Size Image Printer
200 Step
202 Step
204 Step
206 Step
208 Step
210 Step
214 Step
216 Step
218 Step
300 Step
302 Step
304 Step
306 Step
310 Step
312 Step
314 Step
316 Step
318 Step
320 Step
322 Step
324 Step
330 Step
332 Step
334 Step
336 Step
338 Step
340 Step
342 Step
344 Step
346 Step
350 Step
351 Financial Institution
352 Step
353 Remote Database
354 Step
355 Third Party
400 Financial Instrument (custom product)
401 Image
402 Bearer's Signature
403 Location
404 Personal Identification Icon

What is claimed is:

1. A method of conducting a secured kiosk transaction, comprising:
receiving user data comprising personal data, biometric data, or a combination thereof;
comparing the user data to known user information;
performing a transaction; and
providing a detailed record of the transaction to the user,
wherein the transaction is one of safe-deposit or withdrawal of a document, notarization of a document, transportation ticket obtainment, user location verification, or payment of government fees.

2. The method of claim 1, wherein personal data can include one or more of a name, social security number, birth date, account number, password, personal identification number, account number, tax identification number, vehicle identification number, real estate parcel number, license number, passport number, visa number, credit card number, debit card number, or smart card number.

3. The method of claim 1, wherein biometric data comprises one or more of face recognition, fingerprint recognition, iris or retina pattern recognition, voice recognition, vascular pattern recognition, hand recognition, or DNA matching.

4. The method of claim 1, wherein comparing the user data to known user information can be done automatically, by a human being, or a combination thereof.

5. The method of claim 1, wherein the transaction of safe-deposit of the document comprises:
receiving image data of the document to be deposited; and
marking the document image data with date and time of receipt, and user account information.

6. The method of claim 5, wherein receiving image data of the document to be deposited comprises scanning the document, photographing the document, or downloading data corresponding to the document.

7. The method of claim 5, wherein the detailed record of the transaction includes a date of deposit and identifying information of the deposited document.

8. The method of claim 7, wherein identifying information of the deposited document comprises a document title, signatory names, an image of the document, or a combination thereof.

9. The method of claim 1, wherein the transaction of withdrawing the document comprises:
identifying image data of the document to be withdrawn;
marking the document image data with date and time of withdrawal; and
providing a copy of the marked document to user.

10. The method of claim 1, wherein the transaction of notarization of the document comprises:
retrieving image data of the document to be notarized; and
providing a record of notarization to the user including identification of the document notarized, and date and time of notarization.

11. The method of claim 10, wherein retrieving image data of the document to be notarized comprises scanning the document, photographing the document, or downloading data corresponding to the document.

12. The method of claim 10, wherein identification of the document notarized can include a document title, signatory names, an image of the document, or a combination thereof.

13. The method of claim 10, further comprising providing user a copy of the document with indication of notarization on the document.

14. The method of claim 13, wherein indication of notarization includes a date and time of notarization, and identification of the kiosk performing the notary function.

15. The method of claim 1, wherein the transaction of transportation ticket obtainment comprises:
selecting a destination;
providing payment for the ticket; and
printing one or more of a ticket and boarding pass.

16. The method of claim 1, wherein the transaction of transportation ticket obtainment comprises:
identifying a pre-ordered ticket; and
printing one or more of the ticket and a boarding pass.

17. The method of claim 1, wherein the transaction of user location verification comprises:
connecting to a third party person or system; and
confirming user location with the third party person or system.

18. The method of claim 17, wherein connecting to the third party person or system is by wired or wireless telephone, satellite, cable, or wired or wireless internet connection.

19. The method of claim 17, wherein confirming user location includes providing user data to the third party, and providing kiosk identification information.

20. The method of claim 1, wherein the transaction of user location verification comprises providing the detailed record of the transaction to the user, a third party or a combination thereof, wherein the detailed record includes a date and time of kiosk use, identification of the kiosk used, and user data.

21. The method of claim 1, wherein the transaction of payment of government fees comprises:
logging in to a government payment system;
providing user data to the system; and
providing payment.

22. The method of claim 21, wherein the user data comprises a real estate identification number, tax payer identification number, real estate parcel number, or vehicle identification number.

23. The method of claim 1, further comprising:
selecting a transaction type; and
paying a fee for the selected transaction.

24. The method of claim 23, wherein the fee comprises a kiosk usage charge, a bank charge, a ticket fee, a government fee, or a combination thereof.
